(19) United States
(12) Patent Application Publication
(10) Pub. No.: US 2026/0014736 A1
(43) Pub. Date: Jan. 15, 2026

(54) METHOD FOR DRYING BULK MATERIAL, ESPECIALLY GRANULAR PLASTIC MATERIAL, AND DRYING DEVICE FOR SUCH MATERIAL

(71) Applicant: Motan Holding GmbH, Konstanz (DE)

(72) Inventor: Bin WANG, Taicang City (CN)

(73) Assignee: Motan Holding GmbH, Konstanz (DE)

(21) Appl. No.: 18/880,889

(22) PCT Filed: Jul. 5, 2023
(86) PCT No.: PCT/EP2023/068601

§ 371 Date: Jan. 3, 2025

(30) Foreign Application Priority Data
Jul. 5, 2022 (CN) 202221715809.9

(51) Int. Cl. B29B 13/06; B29B 7/24; B29B 7/66; B29B 17/00

(52) U.S. Cl. CPC B29B 13/065; B29B 7/244; B29B 7/66; B29B 17/0005

(57) ABSTRACT

A drying device includes a mixing unit fixedly connected with a drying unit. The drying unit is erected on a bench. The mixing unit includes a virgin material loader and a regrind material loader, which are respectively connected to the top of a mixing component. The bottom of the mixing component is connected with a drying unit through a buffer hopper with level sensor. A drying process with the functions of mixing and drying plastic particles integrates the mixing process and the drying process into a set of processes, saving the control cost and working space. The regrind materials are directly fed by the suction device above the equipment, which can be used as soon as they are produced, reducing the cost of manual treatment and reducing the absorption of air moisture. The user can control the mixing proportion and drying parameters on the control panel at the same time.

### CROSS-REFERENCE TO RELATED APPLICATION

This application is a national stage application, filed under 35 U.S.C. § 371, of International Patent Application PCT/EP2023/068601, filed on Jul. 5, 2023, which claims the benefit of Chinese Patent Application CN 202221715809.9, filed on Jul. 5, 2022.

### TECHNICAL FIELD

The invention belongs to the technical field of plastic product production, in particular to a drying process and a drying device both with plastic particle mixing and drying functions.

### BACKGROUND

In the pretreatment process of plastic particles before plastic products processing, it is often necessary to mix and dry the plastic particles to make the material ratio and drying degree reach a certain proportion before processing. In the traditional way, mixing and drying are two independent sets of equipment, separate control system, and traditional mixer control module. In the process of re application of regrind materials, it is usually until a certain amount of production regrind materials are piled up. The regrind materials are collected manually, mixed with the virgin materials in proportion, and then used again. In the process of collection and reuse, the regrind materials not only consume manpower, but also is exposed to the outside air for a long time in the process of storing and transferring the regrind materials, which is easy to absorb the moisture in the air, thus consuming excess energy to remove this moisture in the subsequent drying process. The waste of labor and energy has virtually increased the production cost. The traditional drying bin control module has a relatively single function. It often only removes the moisture of plastic particles, and cannot add and control the proportion of virgin materials in the drying bin. Moreover, the drying bin and the mixer operate independently and are managed and controlled separately, which takes up too much space, increases the management and control costs, and wastes resources. Therefore, a solution is needed to solve the above problems.

It should be noted that the above contents belong to the inventor's technical cognition and do not necessarily constitute the existing technology.

### SUMMARY

In order to solve the above problems, the invention aims to provide a method and a device for drying plastic particles to reduce the absorption of excess water in the process of storing and transporting regrind materials.

To achieve the above purpose, the invention proposes a method for drying bulk material, especially granular plastic material, which is characterized in that downstream of an injection molding machine regrind material is directly collected and transferred to a mixing unit to be mixed proportionally with virgin material and then to be dried. According to the invention, the regrind material is therefore already prevented from absorbing moisture when it is collected. The regrind material therefore remains largely dry and requires hardly any additional energy for its drying. It even contains less moisture than the virgin material. Its direct collection downstream of the injection molding machine also saves labour. This reduces the manufacturing costs.

In one example, upstream of a mixing chamber the material throughput of regrind material is recorded and in that the throughput of virgin material is increased or decreased as a function of the recorded throughput of regrind material. If a planned portion of regrind material is not available, it is automatically replaced by virgin material. This means that the operation of the injection molding machine in particular is not endangered by a lack of material.

In one example, a drying temperature and/or a drying time and/or an air flow in the drying unit is adjusted as a function of the recorded throughput of regrind material. The percentage detection of the regrind material also makes it possible to directly control the drying unit and to adjust a drying temperature of the drying air and/or a drying time and/or an air flow in the drying unit to the proportion of regrind material of the total material in the drying bin.

To achieve the above purpose, the invention further proposes a drying device, which is characterized in that it includes at least one mixing unit, the mixing unit is fixedly connected with at least one drying unit, the drying unit is erected on a bench, the mixing unit includes at least one virgin material loader and at least one regrind material loader, the virgin material loader and the regrind material loader are respectively connected to the top of at least one dosing unit.

The bottom of a mixing chamber of the mixing unit is advantageously connected with the drying unit through a buffer hopper. Preferably the mixing unit and the drying unit are integrated into a set of equipment, which can not only reduce the absorption of excess water during the storage and transportation of regrind materials, but also reduce the working space and management costs.

In one example, the mixing unit is set in Y-shape, the virgin material loader and the regrind material loader are respectively connected to the top two ends of the dosing units. The return material can be directly fed by a suction device of an upstream equipment, which can be used as soon as it is produced to reduce the absorption of water in the air.

In one example, the mixing unit comprises at least two units. One of these dosing units is for dosing of the virgin material. The other of these dosing units is for dosing regrind material and is preferably equipped with a level sensor to detect whether dosing unit if fed up with the regrind material. If the regrind material is empty, then a control system will compensate the ratio of different materials. The dosing unit of regrind material will stop, and the dosing unit of virgin material will run with full percentage.

In one example, the drying unit has a cylindrical housing. The circumference of the housing is preferably provided with an observation port for operators to observe the internal state of the drying unit.

In one example, the bottom of the drying unit is connected with a discharge channel, and the discharge channel passes through the bench and extends to the lower end face of the bench.

In one example, the mixing unit and the drying unit are both equipped with at least one control device, that is electrically connected to a control panel on the bench. The operator can control the mixing proportion and drying parameters in the control panel at the same time. The visual interface is not only convenient for operation, but also can save control costs.

In one example, a reinforcing ring seat is set between the mixing unit and the drying unit. The reinforcing ring seat preferably is sleeved outside the buffer hopper to share the weight of the buffer hopper and protect the buffer hopper.

The method for integrated intelligent drying and an integrated intelligent drying device both with plastic particle mixing and drying functions proposed by the invention can bring the following beneficial effects:
1. The mixing process and the drying process respectively the mixing unit and the drying unit are integrated into a set of processes or equipment respectively, saving control costs and working space.
2. The regrind materials are directly fed by the suction device above the equipment, which can be used as soon as they are produced, reducing the cost of manual treatment and reducing the absorption of air moisture.
3. The user can control the mixing proportion and drying parameters on the control panel at the same time, saving the control cost, and the visual interface makes the operation more convenient.
4. It can realize functions like automatic drying parameter alteration according to the material composition to the moulding process. Example when the moulding machine is operated with only virgin material then the control system automatically alter the airflow to higher level since virgin material tends to have more moisture than the regrind material which is claimed immediately from the inline granulators. Whenever the moulding process introduce the regrind material and according the percentage the system will change the dry air flow to ensure the right airflow is delivered from the drying system to ensure the right energy consumption and right drying process.

### BRIEF DESCRIPTION OF THE DRAWINGS

The attached drawings described here are used to provide a further understanding of the invention and form a part of it. The schematic embodiments and their descriptions of the invention are used to explain it, and do not constitute an improper limitation of the invention. In the attached drawing:

FIG. 1 is a diagram of method for feeding regrind material to a blender according to the prior art.

FIG. 2 is a diagram of the method for feeding regrind material to a blender according to the invention.

FIG. 3 is the three-dimensional structure diagram of an integrated intelligent drying device with plastic particle mixing and drying functions of the invention.

FIG. 4 is the front view of the integrated intelligent drying device according to FIG. 3.

FIG. 5 in an enlarged front view of the mixing unit of the integrated intelligent drying device according to the invention.

### DETAILED DESCRIPTION

In order to more clearly explain the overall concept of the invention, the following is detailed by way of example in combination with the drawings of the specification.

In the description, it needs to be understood that the terms “center”, “top”, “bottom”, “front”, “back”, “left”, “right”, “vertical”, “horizontal”, “top”, “bottom”, “inside”, “outside”, “axial”, “radial”, “circumferential”, etc. indicate the orientation or position relationship based on the orientation or position relationship shown in the drawings, It is only for the convenience of describing the invention and simplifying the description, rather than indicating or implying that the device or element referred to must have a specific orientation, be constructed and operated in a specific orientation, so it cannot be understood as a limitation of the invention.

In addition, the terms “first” and “second” are only used for description purposes and cannot be understood as indicating or implying relative importance or implicitly indicating the number of indicated technical features. Thus, the features defined as “first” and “second” can explicitly or implicitly include one or more of these features. In the description of the invention “multiple” means two or more, unless otherwise specifically defined.

In the description, unless otherwise specified and defined, the terms “installation”, “connection”, “fixed” and other terms should be understood in a broad sense, for example, they can be fixed connection, removable connection, or integrated. It can be mechanical connection, electrical connection or communication. It can be directly connected or indirectly connected through intermediate media. It can be the internal connection of two components or the interaction between two components. For ordinary technicians in the field, the specific meaning of the above terms in the description can be understood according to the specific situation.

In the description, unless otherwise specified and defined, the first feature “above” or “below” the second feature can be the direct contact between the first and second features, or the indirect contact between the first and second features through an intermediate medium. In the description of this specification, reference to the description of the terms “one scheme”, “some schemes”, “example”, “specific example”, or “some examples” means that the specific features, structures, materials or features described in combination with the scheme or examples are included in at least one scheme or example of this description. In this specification, the schematic expressions of the above terms do not have to refer to the same scheme or example. Moreover, the described specific features, structures, materials or characteristics may be combined in an appropriate manner in any one or more schemes or examples.

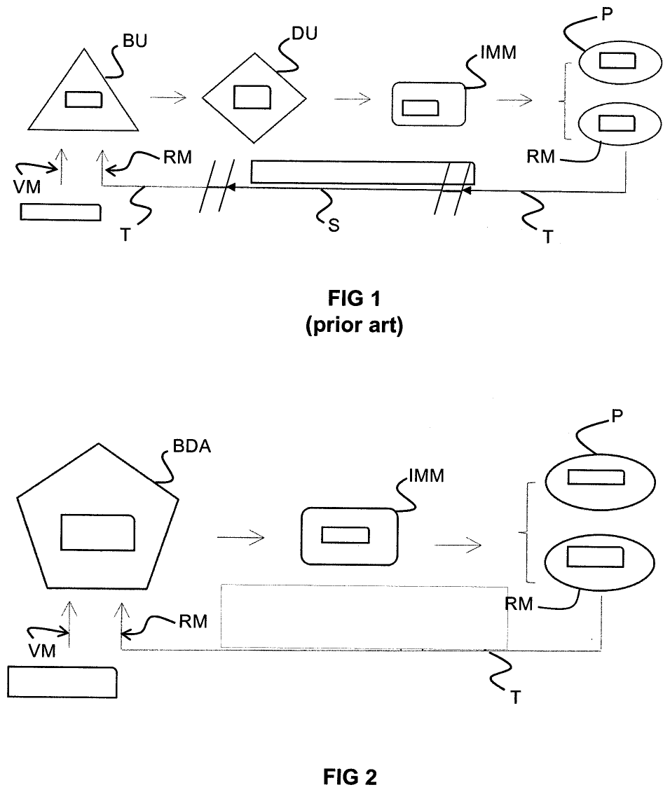

FIG. 1 shows a diagram of a method for feeding regrind material RM to a blender BU according to the prior art. Downstream of an injection molding machine IMM regrind material RM is manually collected and accumulated until a certain amount of it is reached. Once the desired amount of regrind material RM has been achieved, it is fed into a mixer unit BU where it is mixed with virgin material VM according to certain percentages. The mixture is then fed to a separate drying unit DU where it is dried.

Both during storage S and during transport T, the regrind material RM is exposed to the outside air for a long time, which means that it easily absorbs the moisture in the air. During a subsequent drying process, additional energy must be used to remove this moisture again. Depending on the actual humidity, the absorbed moisture of the regrind material RM can fluctuate, making it difficult to control a drying air flow and/or drying temperature in the drying unit DU.

FIG. 2 shows a diagram of the method of integrated intelligent drying with plastic particle mixing and drying functions according to the invention. It also starts downstream of an injection molding machine IMM. There it collects the regrind material RM and transports it directly by means of a conveyor and hopper loader into a combined blender and drying assembly BDA. In the combined blender and drying assembly BDA, the regrind material RM is mixed with virgin material VM according to precisely adjustable and recordable percentage mixing ratios. The mixing ratios are important because they define the intensity and/or temperature and/or duration of the air flow in the drying process with which the mixed material is dried.

According to the invention, the throughput of regrind material RM is therefore already recorded in the blender unit and forwarded to the drying unit of the combined blender and drying assembly BDA. This means that, on the one hand, any regrind material RM still missing in the blender can be compensated for by virgin material VM. On the other hand, the air flow for drying can be adjusted accordingly in the drying unit on the basis of the data from the blender unit.

Since the regrind material is now processed directly and has no prolonged contact with the ambient air, it is not only no longer as moist as in the state of the art, but even drier than the virgin material.

For the drying bin, a standard air flow and a fresh bin mode is possible. The standard air flow is assumed to be 100% for a mixture of 50% regrind material and 50% virgin material. The fresh bin mode will be activated if the material is 100% virgin material, or the return air temperature is lower than a set point. In fresh bin mode i.e. for 100% virgin material, the airflow will be 150% of standard air flow. The larger air flow is more efficient to remove the moisture from material and to improve the drying performance.

Example: Regrind material 50%
Virgin material 50%

If there is no regrind material RM, then more virgin material VM will be dosed by the dosing motor to compensate the throughput, hence more moisture from the virgin material VM also coming inside the drying bin. An inventive control algorithm designed or an operator then intervenes to boost more dry air into the drying bin to get away the additional moisture from the virgin material VM. In the event regrind material RM level reached a preset target value, the control algorithm automatically reduces the air flow to standard level or the operator does this manually. The percentage of the additional air flow is depending on the percentage setting of the regrind material RM. In this case, absence of 50% of the regrind material RM means 50% of additional virgin material VM is coming inside the drying system, hence additional 25% of the standard dry air will be injected to remove more moisture. This additional 25% air flow will continue until the return air temperature of the drying bin exceeded a preset setpoint. Once the setpoint is reached, the air flow will be back to standard air flow.

Example: Regrind material 25%
Virgin material 75%

If there is no regrind material RM, then more virgin material VM will be dosed by the dosing motor to compensate the throughput. In this case, absence of 25% of the regrind material RM means 25% of additional virgin material VM is coming inside the drying system, hence additional 12.5% of the standard dry air will be injected to remove more moisture. This additional 12.5% air flow will continue until the return air temperature of the drying bin exceeded the setpoint. Once the setpoint is reached, the air flow will be back to standard air flow.

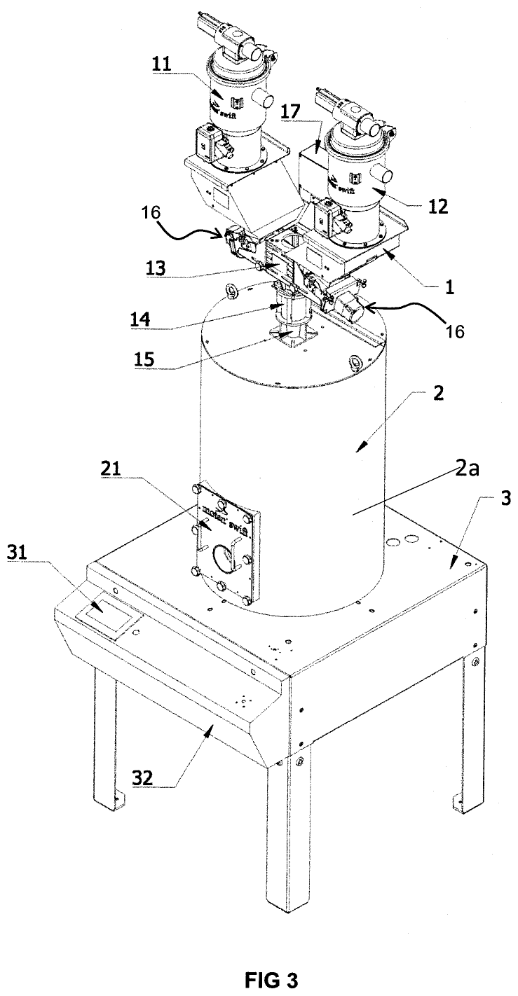

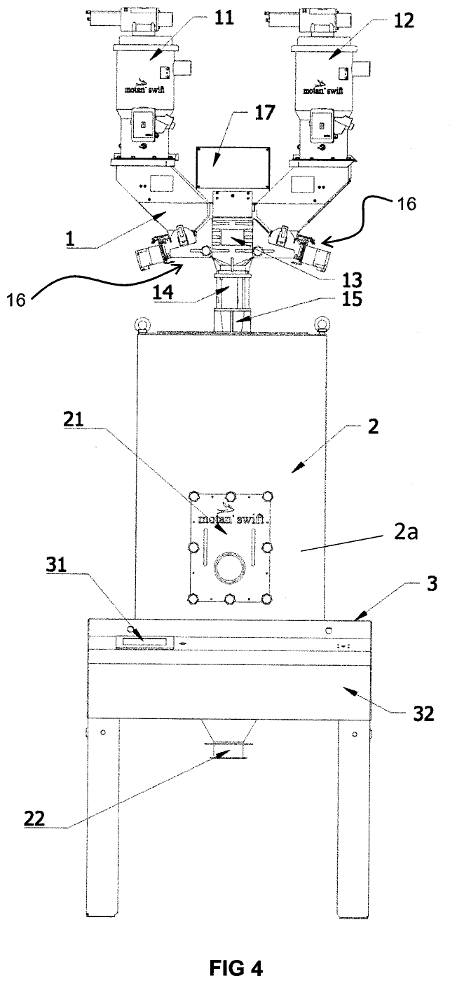

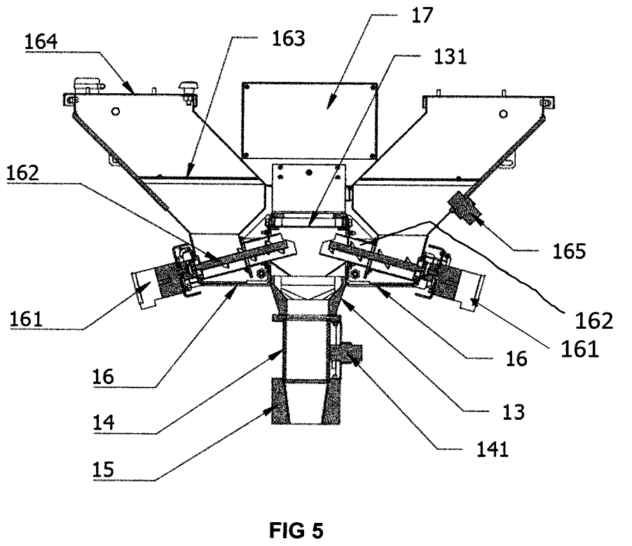

As shown in FIGS. 3 to 5, an embodiment of the invention proposes an integrated intelligent drying device with the functions of mixing and drying plastic particles. It includes a mixing unit 1, which is fixedly connected with a drying unit 2 to form the combined blender and drying assembly BDA according to FIG. 2. The drying unit 2 is erected on a bench 3 or the like.

The mixing unit 1 includes a virgin material loader 11 for the virgin material VM and a regrind material loader 12, which are respectively connected to the top of dosing units 16. The two dosing units 16 are connecting with a mixing chamber 13 from both sides. The bottom of the mixing chamber 13 is connected to the drying unit 2 through a buffer hopper 14, which is preferably a cylindrical pipe piece.

Each dosing unit 16 is equipped with a dosing motor 161, a dosing screw 162, a protection sieve 163 preventing the dosing screw 162 from damage by contamination and a hinged lid 164. The dosing motor 161 is driven by motor box 17. Each dosing screw 162 is inclined upwards and is rotated by dosing motor 161. The material in dosing unit 16 coming down from the material loader 11, 12 is fed by dosing screw 162 upwards until the material falls down into the mixing chamber 13. The dosing unit 16 on the right hand side in the FIGS. 3 to 5, which is used for dosing the regrind material RM, is equipped with a level sensor 165 to detect the level of regrind material RM in the dosing unit 16. The dosing unit 16 on the left hand also can be equipped with a level sensor.

Downstream the mixing chamber 13 there is the tubular and preferably transparent buffer hopper 14 with a level sensor 141. The transparent buffer hopper 14 leads through a reinforcing ring seat 15 into the drying unit 2.

The dosing units 16, especially the motor box 17, are designed to not necessarily operate the motors 161 synchronously, but to control them individually, for example to run at different speeds or at different times. The individual control of the motors 161 can therefore determine the percentage ratio of virgin material VM and regrind material RM that is loaded into the mixing chamber 13.

The mixing unit 1 and the drying unit 2 are integrated into a set of equipment, which can not only reduce the excess water absorption during the storage and transportation of the regrind materials RM due to its direct usage for production, but also reduce the working space and management costs.

The material is fed to the loaders 11, 12 in a known manner, e.g. by a suction process.

The mixing unit 1 is arranged in a Y-shaped shape. The virgin material loader 11 and the regrind material loader 12 are respectively connected to the top two ends of the dosing unit 16. According to the invention the regrind materials can be directly fed by the regrind material loader 12. It can be used directly with production. At the same time the direct usage of the regrind material reduces its absorption of moisture in the air, therefore reducing the expenses for removing moisture from the regrind material.

The drying unit 2 has a preferably cylindrical housing 2a. On a front side of the housing 2a facing an operator, it includes an observation port 21. The observation port 21 is set around the drying unit 2 to facilitate the operator to observe the state of the two materials in the drying unit 2.

The bottom of the drying unit 2 is connected with a discharge channel 22. The discharge channel 22 passes through the bench 3 and extends to a lower end of the bench 3. The discharge channel 22 has a (not shown) slide, with which the discharge channel 22 can be opened or closed.

The mixing unit 1 and the drying unit 2 are equipped with control devices.

The mixing unit 1 is equipped with the motor box 17, driving the dosing motors 161.

The control devices are electrically connected with a control cabinet 32 on the bench 3 facing the operator. A control panel 31 is installed on the control cabinet 32. The control panel 31 is the controller of mixing unit 1. The controller of drying unit 2 is equipped in the control cabinet 32. The control panel 31 is a Human-Machine-Interface of drying unit 2. The operator can set the mixing proportion, dosing throughput, drying temperature, drying time and recipe in the control panel 31 at the same time. The visual interface is not only convenient for operation, but also can save control costs.

The reinforcing ring seat 15 is set between the mixing unit 1 and the drying unit 2. The reinforcing ring seat 15 is sleeved outside the buffer hopper 14 to share the weight of the buffer hopper 14 and protect the buffer hopper 14. The buffer hopper 14 is equipped with the level sensor 141 which is detecting the material in buffer hopper 14. If the material is full, system will stop the dosing process. If it is empty, the mixing unit 1 will be started by control system.

Each embodiment in this specification is described in a progressive manner. The same and similar parts of each embodiment can be referred to each other. Each embodiment focuses on the differences with other embodiments. In particular, for the system embodiment, since it is basically similar to the method embodiment, the description is relatively simple. Please refer to the partial description of the method embodiment for details.

The above is only an embodiment of the invention, and is not used to limit it. For those skilled in the art, the invention can have various changes. Any modification, equivalent replacement, improvement, etc. made within the spirit and principle of the invention shall be included in its claims.

1. A method for drying bulk material, especially granular plastic material,
wherein downstream of an injection molding machine (IMM) regrind material (RM) is directly collected and transferred to a mixing unit (1) to be mixed proportionally with virgin material (VM) and then to be dried.

2. The method according to claim 1,
wherein upstream of a mixing chamber (13) a material throughput of regrind material (RM) is recorded and
wherein a throughput of virgin material (VM) is increased or decreased as a function of the recorded material throughput of regrind material (RM).

3. The method according to claim 2,
wherein a drying temperature and/or a drying time and/or an air flow in a drying unit (2) is adjusted as a function of the recorded material throughput of regrind material (RM).

4. A drying device for carrying out the method according to claim 1, comprising:
at least one mixing unit (1), the at least one mixing unit (1) being fixedly connected with
at least one drying unit (2), the at least one drying unit (2) being erected on
a bench (3),
wherein the at least one mixing unit (1) includes at least one virgin material loader (11) and at least one regrind material loader (12), and
wherein the at least one virgin material loader (11) and the at least one regrind material loader (12) are respectively connected to a top of at least one dosing unit (16).

5. The drying device according to claim 4, wherein a bottom of a mixing chamber (13) of the at least one mixing unit (1) is connected with the at least one drying unit (2) through a buffer hopper (14).

6. The drying device according to claim 4,
wherein the at least one mixing unit (1) comprises at least two dosing units (16),
wherein one of the at least two dosing units (16) is for dosing of the virgin material (VM) and another of the at least two dosing units (16) is for dosing regrind material (RM),
whereby the other of the at least two dosing units (16) for dosing the regrind material (RM) is equipped with a level sensor (165) to detect a level of the regrind material.

7. The drying device according to claim 4,
wherein the at least one mixing unit (1) is arranged in Y-shape, and
wherein the at least one virgin material loader (11) and the at least one regrind material loader (12) are respectively connected at the top and both ends of the at least two dosing units (16).

8. The drying device according to claim 4,
wherein the at least one drying unit has a cylindrical housing (2a) and
wherein a circumference of the cylindrical housing (2a) is provided with an observation port (21) for an operator to observe an internal state of the drying unit (2).

9. The drying device according to claim 4,
wherein a bottom of the at least one drying unit (2) is connected with a discharge channel (22), and
wherein the discharge channel (22) passes through the bench (3) and extends to a lower end face of the bench (3).

10. The drying device according to claim 4,
wherein the at least one mixing unit (1) and the at least one drying unit (2) are both equipped with at least one control device, that is electrically connected to a control panel on the bench (3).

11. The drying device according to claim 5,
wherein a reinforcing ring seat (15) is arranged between the at least one mixing unit (1) and the at least one drying unit (2), and
wherein the reinforcing ring seat (15) is sleeved outside the buffer hopper (14).
